(19) United States
(12) Patent Application Publication
(10) Pub. No.: US 2018/0284810 A1
(43) Pub. Date: Oct. 4, 2018

(54) METHOD FOR ESTABLISHING A COOPERATION PARTNER FOR EXECUTING A DRIVING MANEUVER AND A SYSTEM

(71) Applicant: Continental Teves AG & Co. oHG, Frankfurt (DE)

(72) Inventors: Sebastian Strunck, Niedernhausen (DE); Marc Menzel, Weimar (Lahn) (DE); Jonas Schönichen, Weiterstadt (DE); Thomas Grotendorst, Eschborn (DE); Marc Simon, Darmstadt (DE)

(73) Assignee: Continental Teves AG & Co. oHG, Frankfurt (DE)

(21) Appl. No.: 15/937,169

(22) Filed: Mar. 27, 2018

(30) Foreign Application Priority Data
Mar. 28, 2017 (DE) 10 2017 205 230.9

(51) Int. Cl. G05D 1/02

(52) U.S. Cl. CPC G05D 1/0289; H04W 4/40; G05D 1/0276

(57) ABSTRACT

A method for establishing a cooperation partner for executing a driving maneuver, includes emission of a cooperation request by a first vehicle and receiving of the cooperation request by a second vehicle. The method also includes establishing of a significance value for cooperation on the basis of information included in the cooperation request, using information relating to the second vehicle, by the second vehicle. The method also includes emission of a piece of information focused on the cooperation request by the second vehicle.

### CROSS REFERENCE TO RELATED APPLICATION

This application claims priority to German patent application No. 10 2017 205 230.9, filed Mar. 28, 2017, which is hereby incorporated by reference.

### TECHNICAL FIELD

The technical field relates to a method and system for establishing a cooperation partner for executing a driving maneuver.

### BACKGROUND

Vehicle-to-X communication allows cooperative driving and, therefore, agreement between road users to execute maneuvers, in particular to avoid collisions. One difficulty of such distributed systems is detecting an appropriate cooperation partner, among many, for a maneuver to be executed at a given time and location. This is particularly evident in the case of comparatively large traffic volumes or at higher speeds.

As such, it is desirable to present and method and system to achieve an agreement between road users with as low a volume of communication as possible. In addition, other desirable features and characteristics will become apparent from the subsequent summary and detailed description, and the appended claims, taken in conjunction with the accompanying drawings and this background.

### BRIEF SUMMARY

According to one exemplary embodiment, a method for establishing a cooperation partner for executing a driving maneuver includes emission of a cooperation request by a first vehicle. The method also includes receiving of the cooperation request by a second vehicle. The method further includes establishing of a significance value for cooperation on the basis of information included in the cooperation request, using information relating to the second vehicle, by the second vehicle. The method also includes emission of a piece of information focused on the cooperation request by the second vehicle.

The term “significance value for cooperation” denotes, in particular, a piece of qualitative and/or quantitative information regarding what significance can be conceded to a second vehicle which receives the cooperation request, for cooperation with the vehicle emitting the cooperation request, e.g., in the form of an indicator or respectively a numerical value. For example, the significance value describes a piece of information characterizing the relevance for cooperation of a relevant road user with a road user emitting a cooperation request. Accordingly, the significance value can preferably denote a quantified statement regarding the extent to which the second vehicle—in view of the current information situation—would presumably be included in the planned maneuver with the first vehicle, or respectively to what extent the vehicles would influence each other at the anticipated time and location. In particular, the driving maneuver of the first vehicle influences or respectively includes the second vehicle in the case of predicted trajectories of the first vehicle and second vehicle overlapping in time and location, in particular at the location of the planned driving maneuver. The information focused on the cooperation request is, in this case, expediently comprised by a corresponding message. The message can be provided to transmit this information or the information is embedded in a message of a different type.

It should be appreciated that a significance for communication of one road user with a road user emitting a cooperation request is determined on the part of the potential cooperation partner receiving the request. The cooperation request may be effected without specifically addressing an individual road user, i.e., as a broadcast. The communication outlay in advance of a maneuver can consequently be kept low. By comparison, the volume of communication would be considerably higher if the road users receiving a request were to send the required data for determining a cooperation participant to the initiating vehicle and the vehicle emitting the request were to carry out an evaluation.

Since the significance value is determined by each vehicle itself, this can furthermore avoid influencing from externally, as a result of which cooperation can merely take place knowingly and willingly. The cooperation request is expediently configured as a vehicle-to-X message.

The information focused on the cooperation request may be only emitted if a predetermined condition which is dependent on the significance value is satisfied. The established significance value is particularly preferably emitted as information focused on the cooperation request. It may be provided that the information focused on the cooperation request is the significance value, whereby the determined significance value is emitted as such in response to the cooperation request.

According to one further embodiment, the timing of an emission of a piece of information focused on the cooperation request is delayed as a function of an established value of the significance value, wherein the time delay is, in particular, increased as the significance for cooperation for executing the driving maneuver becomes smaller. In this respect, the dependency of the delay on the established value of the significance value is specified as a predetermined condition. Vehicles having a high relevance for cooperation are consequently given the possibility of emitting their message at an earlier time than vehicles having low significance for the communication. In one embodiment, the vehicle having the highest significance value would be the first to emit a piece of information focused on the cooperation request, whereupon on receipt by other vehicles, these could refrain from emitting information, as a result of which the communication outlay for establishing a cooperation partner for executing a driving maneuver can be very efficiently planned.

The time delay of the emission as a function of the significance value can be provided over the entire value range of the significance value or merely over a part thereof. If, for example, a limit for defining a minimum significance value for emission is provided, the dependency is expediently only provided for larger significance values. In addition, a second limit of the significance value can be provided, as of which second limit an emission essentially takes place without a delay. In these cases, the limit or limits represent(s) the predetermined condition, possibly in conjunction with the time delay.

The significance value may be emitted by the second vehicle without specifically addressing a road user, in particular the first vehicle. Consequently, it may involve a broadcast emission. Alternatively or in addition, an addressed emission, in particular to the first vehicle emitting the communication request, can be provided.

Furthermore, the method may include receiving of the information focused on the cooperation request by the first vehicle, and evaluating of the received information focused on the cooperation request regarding the significance of the second vehicle as a cooperation partner for executing the driving maneuver.

Furthermore, the method may also include commencing of a unicast communication of the first with the second vehicle on the basis of the evaluation of the significance of the vehicle as a cooperation partner for executing the driving maneuver.

The unicast communication is expediently commenced with the second vehicle if a high, e.g., a maximum, significance of the second vehicle is produced for the execution of the driving maneuver with the first vehicle. Accordingly, addressed communication may take place. Respective unicast communications of the first vehicle with additional vehicles can preferably also be carried out, in order to plan the execution of the driving maneuver.

The cooperation request may include information describing a current and/or predicted state of the first vehicle. The information may include, but is not limited to:
a position of the first vehicle,
a speed of the first vehicle,
an acceleration of the first vehicle,
a steering angle of the first vehicle,
a planned route of the first vehicle, for example from navigation data or respectively actuation of a turn indicator,
a distance from the location of the planned driving maneuver,
at least one correction factor based on a learnt driver behavior of a vehicle operator, and/or
at least a part of an anticipated trajectory of the first vehicle.

The transmitted information can additionally include at least one piece of assigned information, in each case, regarding a confidence measure of the respective state information, in particular in the form of a standard deviation or variance, or respectively a piece of information describing the spatial and/or temporal probability of presence as well. For example, the trajectory or respectively the relevant part or point of the trajectory consequently advantageously reflects time-dependent and/or location-dependent probabilities of presence or respectively uncertainties in the prediction of the trajectory of the first vehicle. Consequently, statements can be made regarding the time at which the first vehicle will be, with which probability, at a location relating in particular to the planned maneuver. As part of the anticipated trajectory, it can be expediently provided that a part which is presumably relevant to the maneuver is merely emitted, wherein the part can also be an anticipated location at an anticipated time. In particular, the speed and/or the acceleration of the first vehicle can expediently also be transferred as a vector variable in order to describe the amount as well as the direction.

The information relating to the second vehicle, which is to be used in order to establish the significance value, may be information describing a current and/or predicted state of the second vehicle. Consequently, this can in particular be information which can be detected by a vehicle bus of the second vehicle. Therefore, in the case of the information describing the state of the second vehicle in order to determine the significance value, at least one piece of assigned information in each case regarding a confidence measure of the respective state information, or respectively a piece of information describing the spatial and/or temporal probability of presence can be used, as has already been described for the information transferred by the first vehicle.

According to another embodiment, the significance value for cooperation with the first vehicle is established on the basis of how the state of the second vehicle would have to be changed, so as not to be uninfluenced by the driving maneuver of the first vehicle, for example how a speed and/or acceleration would have to be adjusted. As the adjustment becomes more necessary, the value of the significance value falls accordingly. For example, this results in a comparatively high computational efficiency if the vehicle emitting a cooperation request is to merge with a flow of traffic which is substantially moving in a straight line, since merely the ego speed or respectively ego acceleration need to be used as parameters for calculation by a vehicle receiving the request.

The significance value for cooperation with the first vehicle is expediently established on the basis of how the state of the second vehicle would have to be changed, in order to achieve an at least partial temporal and spatial overlapping of predicted trajectories of the first vehicle and of the second vehicle, in particular at the planned location of the maneuver. A partial temporal and spatial overlapping can, for example, be established in that the spatial and/or temporal probabilities of presence or respectively confidence measures overlap, or a possible reciprocal influencing and/or a collision could already occur due to the physical expanses of the vehicles.

The information relating to the second vehicle, which is to be used in order to determine the significance value, may include, but is not limited to:
a position of the second vehicle,
a speed of the second vehicle,
an acceleration of the second vehicle,
a steering angle of the second vehicle,
a planned route of the second vehicle, for example from navigation data or respectively actuation of a turn indicator,
a distance from the location of the planned driving maneuver,
a learnt driver behavior of a vehicle operator, e.g. in the form of a correction value, and/or
at least a part of an anticipated trajectory of the second vehicle.

In particular, the speed and/or the acceleration of the second vehicle can expediently also be transferred as a vector variable in order to describe the amount as well as the direction. It can be provided that the driving behavior of a vehicle operator of the first vehicle is included in the establishment of the significance value. The driving behavior can, in this case, be usual diving behavior which has in particular been learnt. For example, it could be presumed, based on the usual driving behavior, that the driver would probably not accept an adjustment of his own driving parameters, whereupon the significance value to be emitted is preferably reduced, e.g., to a value of zero, or is not emitted. Consequently, this may be likewise be incorporated into the predetermined condition for emission. In this respect, it is true that the second vehicle can essentially be significant to the driving maneuver of the first vehicle, however due to the lack of a willingness to cooperate, no higher significance value can be produced.

In accordance with another further embodiment, the second vehicle only emits the information focused on the cooperation request if, based on the determined significance value, a significance for communication above a defined limit is established for a driving maneuver with the first vehicle. If the value of the relevance indicator exceeds a defined limit, the significance value or respectively a value derived therefrom is preferably emitted by the second vehicle. Correspondingly, no emission preferably occurs if, based on the determined significance value, a significance for communication below a defined limit is established for a driving maneuver. Vehicles establishing a low relevance for communication for the execution of a maneuver with regard to the vehicle emitting the request will consequently not emit any response to the request, thus reducing the volume of communication.

According to one embodiment, the information focused on the cooperation request is not emitted by the second vehicle if, prior to the emission, information focused on the cooperation request has already been received from a third vehicle in response to the cooperation request. As a result, the volume of communication can be further reduced in an advantageous manner.

The significance value may be compared over a plurality of vehicles and/or the calculation basis of the significance value is effected in a comparable manner for a plurality of vehicles. In particular, the significance value and/or the calculation basis of the significance value is/are standardized. The significance value and/or the calculation basis of the significance value may be subject to a standard. Consequently, an evaluation of the relevance for cooperation with the vehicle emitting the request by the second vehicle is possible in an advantageous manner.

The establishment of the significance value by the first and/or second vehicle is continually updated during the course of the unicast communication of the vehicles. In the event of the significance value falling below a limit, the method may be restarted by emitting a cooperation request and/or the cooperative maneuver is interrupted. The information exchanged during the unicast communication may include, but is not limited to, the following:
the position of the first vehicle,
the speed of the first vehicle, for example as a vector,
the acceleration of the first vehicle, for example as a vector,
a presumably planned route of the first vehicle, and/or
a cooperation status, for example a desired aborting of the method or desired continuation.

It may also be provided that the cooperation request and/or the significance value is/are embedded in a data format of a message, which is usually repeatedly emitted cyclically, such as, e.g., an extended Cooperative Awareness Message (CAM, Europe) or a Basic Safety Message (BSM, USA).

According to another aspect, a system for vehicle-to-X communication, including a first electronic control unit for vehicle-to-X communication of a first vehicle and a second electronic control unit for vehicle-to-X communication of a second vehicle, is set up to execute a method as described herein.

In a further development of the indicated electronic control units, these indicated control units may each have at least one storage device and a processor. In this case, the indicated method is stored in the form of a computer program in the storage devices and the processors are provided for cooperatively executing the method if the computer program is loaded from the storage devices into the processors.

According to another aspect, a computer program includes program coding in order to perform all or some of the functions of the indicated method if the computer program is run on a computer or one of the indicated apparatuses.

According to another aspect, a computer program product contains a program code which is stored on a computer-readable data carrier and which, when it is run on a data processing device, performs one of the indicated methods.

### BRIEF DESCRIPTION OF THE DRAWINGS

Other advantages of the disclosed subject matter will be readily appreciated, as the same becomes better understood by reference to the following detailed description when considered in connection with the accompanying drawings wherein:

FIG. 1 shows an exemplary application at a T-junction in order to explain the method.

### DETAILED DESCRIPTION

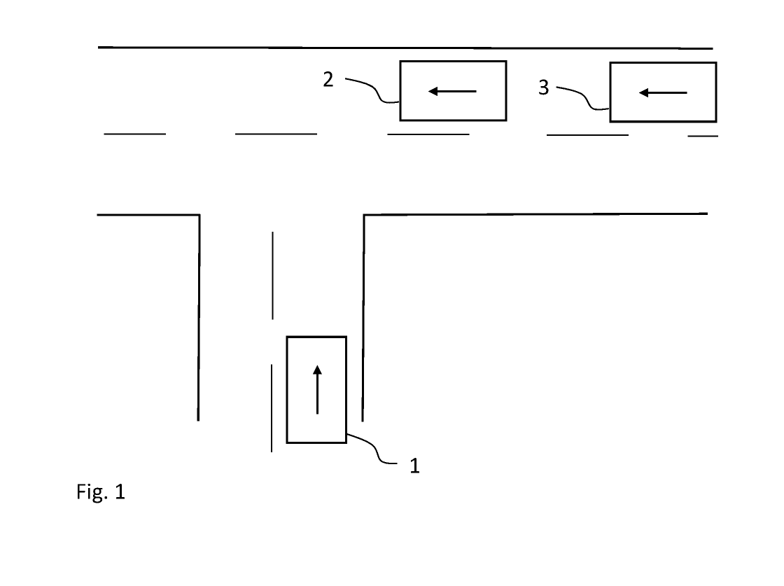

FIG. 1 shows an exemplary application at a T-junction in order to explain the method described herein. The directions of movement of vehicles 1, 2, 3 are indicated by arrows. A first vehicle 1 emits a cooperation request into the surroundings by means of a device for vehicle-to-X communication, which comprises the information that the vehicle intends to turn left at the illustrated T-junction in order to join the traffic, represented by second and third vehicles 2, 3. This can, for example, be information regarding an already calculated projected trajectory of the first vehicle 1, if necessary taking account of time-dependent and/or location-dependent probabilities of presence. The cooperation request can, alternatively or in addition to the aforementioned information, also include, for example, information about the ego speed/acceleration of the vehicle, approximate distance from the location of the planned maneuver and/or correction factors based on a learnt driver behavior.

The second and third vehicles 2, 3 in the environment of the first vehicle 1 receive the cooperation request and, in each case, determine a significance indicator for cooperation based on the received information, taking account in each case of their own parameters, for example the driving speed, the vehicle acceleration, the steering angles, the road topology based on map data and/or a driver wish, for example based on a route plan of the navigation system.

The significance indicator for cooperation is determined on the basis of a probability value of the calculated or received trajectory of the first vehicle 1 and the projected trajectory of each of the second and third vehicles 2, 3, which are determined based on their own parameters, coinciding. In this case, the projected trajectories also illustrate location-dependent and/or time-dependent probabilities of presence, as a result of which the uncertainties of the prediction can be considered. The smaller the probability value determined in such a way is, the smaller the significance for cooperation with the vehicle emitting the request is.

It can also alternatively be provided that the significance indicator for cooperation is determined on the basis of how extensively the vehicle's own state, e.g., the speed, would have to be changed, in order to obtain a coincidence with the calculated or received trajectory of the first vehicle 1. As the adjustment becomes more necessary, the value of the significance indicator decreases accordingly. For cases such as, for example, the merger of a vehicle emitting a request with the traffic comprising vehicles driving substantially in a straight line, this calculation basis can be comparatively computationally efficient.

In accordance with the embodiment example, the second and third vehicles 2, 3 each calculate a significance value. If this is larger than a defined limit, the calculated value is sent by means of vehicle-to-X communication. According to the example, the third vehicle 3 has calculated a higher significance value. The first vehicle 1 can determine the most expedient cooperation partner for the planned maneuver with the information thus obtained and, for this purpose, can commence communication with the third vehicle 3 focused on agreement to carry out the maneuver.

The determination of the significance indicator by the third vehicle 3 is, furthermore, continually updated. In the event of the significance value dropping, the method may be restarted by emitting a cooperation request and/or the cooperative maneuver is interrupted.

It is further pointed out that configurations, features and variants, which are described in the various embodiments or embodiment examples and/or shown in the figures, can be combined with one another as desired. Individual or multiple features are interchangeable as desired. Resulting combinations of features are understood to also be covered by the disclosure of this application.

Back references in subordinate claims should not be construed as a waiver of the attainment of independent, objective protection for the features of the subordinate claims referred back to. These features can also be used in any combination with other features.

Features which are merely disclosed in the description or features which are disclosed in the description or a claim only in conjunction with other features can, in principle, be of independent inventive relevance. They can therefore also be included separately in claims to distinguish from the prior art.

It should be pointed out in general that vehicle-to-X communication means, in particular, a direct communication between vehicles and/or between vehicles and infrastructure facilities. For example, therefore, vehicle-to-vehicle communication or vehicle-to-infrastructure communication may be involved. Where communication between vehicles is referred to within the framework of this application, this can essentially, for example, take place within the framework of vehicle-to-vehicle communication, which typically takes place without the intermediary of a mobile network or a similar external infrastructure and which can therefore be distinguished from other solutions which, for example, are based on a mobile network. For example, vehicle-to-X communication can take place using the standards IEEE 802.11p or IEEE 1609.4. Vehicle-to-X communication can also be referred to as C2X communication. The sub-areas can be referred to as C2C (Car-to-Car) or C2I (Car-to-Infrastructure). The invention expressly does not, however, exclude vehicle-to-X communication with the intermediary of, for example, a mobile network.

The present invention has been described herein in an illustrative manner, and it is to be understood that the terminology which has been used is intended to be in the nature of words of description rather than of limitation. Obviously, many modifications and variations of the invention are possible in light of the above teachings. The invention may be practiced otherwise than as specifically described within the scope of the appended claims.

What is claimed is:

1. A method for establishing a cooperation partner for executing a driving maneuver, said method comprising:
emission of a cooperation request by a first vehicle,
receiving of the cooperation request by a second vehicle,
establishing of a significance value for cooperation on the basis of information comprised by the cooperation request, using information relating to the second vehicle, by the second vehicle, and
emission of a piece of information focused on the cooperation request by the second vehicle.

2. The method according to claim 1, wherein the information focused on the cooperation request is only emitted if a predetermined condition which is dependent on the significance value is satisfied.

3. The method according to claim 1, wherein the established significance value is emitted as information focused on the cooperation request.

4. The method according to claim 1, wherein the timing of an emission of a piece of information focused on the cooperation request is delayed as a function of an established value of the significance value.

5. The method according to claim 1, wherein the information focused on the cooperation request is emitted by the second vehicle without specifically addressing a road user.

6. The method according to claim 1, further comprising:
receiving of the information focused on the cooperation request by the first vehicle, and
evaluating of the received information focused on the cooperation request regarding the significance of the second vehicle as a cooperation partner for executing the driving maneuver.

7. The method according to claim 1, wherein the cooperation request comprises information describing a current and/or predicted state of the first vehicle.

8. The method according to at least one of the preceding claims, wherein the cooperation request includes at least one of:
a position of the first vehicle,
a speed of the first vehicle,
an acceleration of the first vehicle,
a steering angle of the first vehicle,
a planned route of the first vehicle,
a distance from the location of the planned driving maneuver,
at least one correction factor based on a learnt driver behavior of a vehicle operator, and
at least a part of an anticipated trajectory of the first vehicle.

9. The method according to claim 1, wherein the information relating to the second vehicle, which is to be used in order to establish the significance value, is information describing a current and/or predicted state of the second vehicle.

10. The method according to claim 1, wherein the significance value for cooperation with the first vehicle is established on the basis of how the state of the second vehicle would have to be changed, so as not to be uninfluenced by the driving maneuver of the first vehicle.

11. The method according to claim 1, wherein the significance value for cooperation with the first vehicle is established on the basis of how the state of the second vehicle would have to be changed, in order to achieve an at least partial temporal and spatial overlapping of predicted trajectories of the first vehicle and of the second vehicle.

12. The method according to claim 1, wherein the information relating to the second vehicle, which is to be used in order to establish the significance value, comprises at least one of:
a position of the second vehicle,
a speed of the second vehicle,
an acceleration of the second vehicle,
a steering angle of the second vehicle,
a planned route of the second vehicle,
a distance from the location of the planned driving maneuver,
a learnt driver behavior of a vehicle operator, and
at least a part of an anticipated trajectory of the second vehicle.

13. The method according to claim 1, wherein the second vehicle only emits the information focused on the cooperation request if, based on the determined significance value, a significance for communication above a defined limit is established for a driving maneuver with the first vehicle.

14. The method according to claim 1, wherein the information focused on the cooperation request is not emitted by the second vehicle if, prior to the emission, information focused on the cooperation request has already been received from a third vehicle in response to the cooperation request.

15. The method according to claim 1, wherein the significance value can be compared over a plurality of vehicles and/or the calculation basis of the significance value is effected in a comparable manner for a plurality of vehicles.
